(19) United States
(12) Patent Application Publication
(10) Pub. No.: US 2002/0025334 A1
(43) Pub. Date: Feb. 28, 2002

(54) PROTECTIVE BARRIER COMPOSITION

(76) Inventor: RORY SMITH, NORTH YORKSHIRE (GB)

Correspondence Address: JACOBSON PRICE HOLMAN & STERN, 400 SEVENTH STREET NW, WASHINGTON, DC, 20004

(21) Appl. No.: 09/356,000

(22) PCT Filed: Feb. 26, 1998
(86) PCT No.: PCT/GB98/00454

(30) Foreign Application Priority Data
Feb. 26, 1997 (GB) 9704022.4

(51) Int. Cl. A01N 25/34

(52) U.S. Cl. 424/402

(57) ABSTRACT

A composition for application to human or animal skin comprising first and second fluid components, wherein the first component is adapted to be applied to contact the skin, and the second component is adapted to be applied to contact the first component, whereby first and second components in combination are adapted to provide a bilayer comprising a therapeutic layer to contact the skin and a (semi) solid barrier layer, wherein the bilayer is adapted to provide a cohesion which is less than its adhesion, a process for the preparation thereof components thereof and the use thereof in aiding healing, repair and/or protection of human or animal skin.

The present invention relates to a protective barrier composition, components thereof, a process for the preparation thereof, a method for the application thereof and the uses thereof. More particularly the invention relates to a protective barrier composition for the application to human or animal skin, components thereof, the process for the preparation thereof, and the method for application to human or animal skin and use thereof in aiding the healing, repair and/or protection of human or animal skin.

A composition to be effective in aiding healing, repair and/or protection of human skin must meet quite a number of very exacting requirements in order to fulfill all the functions ordinarily performed by the skin, without disruption of the conditions which are essential to healing and repair of skin.

Skin is an effective and resilient barrier. It is resilient to even strong acids but more vulnerable to alkaline substances. In cross section, it can be seen that the skin consists of an outer layer called the “epidermis” and a lower layer called the “dermis”.

The outer horny layer of the epidermis consists of dead cells which are constantly being shed by the body. These cells are constly replaced by cells which originate in the basal layer of the epidermis and migrate upwards, taking about 15 days to move through the three living layers of the epidermis.

The cells of the outer skin layer serve as a rate limiting membrane which affect the passage of ions and molecules. This layer protects against harmful chemicals but admits topical allergens and topical therapy. It also yields sensible water as perspiration. Transport across this membrane is enhanced by increased temperature and by increased hydration.

Where the epidermis deeply invaginates the much thicker dermis, relatively open portals of entry exist for microorganisms, irritants and allergic sensitizers.

The presence of an intact horny layer is essential for the normal functioning and integrity of the skin. The thickness of the layer varies, and in the abdomen, which is of high susceptibility to damage in stoma care, is only between 0.1 to 0.2 mm thick.

There are three main groups of skin problems caused by (partial) damage to the outer skin layer, and these occur mostly in stoma care, incontinence, (breast) prosthesis attachment, dressing of existing skin wounds, skin diseases such as eczema, nappy rash, erothema and dermatitis, and the like. These are Excoriation, Physical Stress, and Irritation.

Excoriation is caused by leakage. This occurs in stoma care when digestive enzymes present in the gut, which are highly alkaline, leak onto the peristomal skin and thus, digest the skin Faecal and urinary fluids are similarly highly corrosive and excoriating. In cases like these, adequate skin protection is very important.

Physical stress occurs each time an adhesive is stripped from the skin removing the top layer of dead cells, usually causing a slight reddening. Repeated removal of an aggressive adhesive without giving the dead cell layer time to regenerate, leads to reddening and soreness. Removal of an extremely aggressive adhesive will remove even the bottom layer of dead cells and fluid may then be exuded. This makes it very difficult to apply a further adhesive appliance without rendering the epidermis more susceptible to topical irritation and infection. In cases of supporting and sealing medical devices by adhesion, the adhesive should be as gentle as possible so as not to strip even the top layer of dead cells. Physical stress can also result from abrasion and chaffing of ill fitting, non-conformable or non-flexible pads, dressings, devices and the like.

Irritation and allergic reactions arise by irritation of the living skin cells, typically by contact with irritant substances via (partially) damaged outer skin, or by absorption of the irritant substances via intact skin. These reactions cause both contact dermatitis and eczema. Occluding the skin increases absorption of some substances of up to 100 fold. An allergy is a hyper sensitive state acquired through exposure to a particular allergen, re-exposure bringing to light an altered capacity to react. An allergic reaction to an adhesive occurs when a compound is formed between one or more constituents in the adhesive (allergens) and the epidermis, which is carried to the lymph system. On re-exposure to the allergen antibodies, or sensitised lymphocytes, will be formed which produce a skin reaction.

Washers and wafers are now available which minimise each of these three problems, in stoma care. The washers and wafers provide a seal to prevent leakage of excoriating fluids, made from a base of carboxymethyl cellulose (CMC) which has moisture absorbing properties and is non-irritant so it can be used on even wet and weeping skin. The degree of adhesion and flexibility may be varied by the formulation. Adhesives are based on synthetic rubbers and mixtures of absorbent materials such as CMC, gelatine and pectin. Nevertheless these adhesives still cause skin breakdown.

The probability of skin breakdown is compounded in male incontinence, with the use of adhesives to secure devices such as male sheaths in position and in ileostomy, due to the excoriating effects of urine and ileostomy effluent respectively on skin already traumatised by adhesives.

The above skin problems are also prevalent in skin care requiring the use of non-adhesive pads and the like by sufferers of urinary and faecal incontinence. Again the effluent itself is often excoriating due to the corrosive nature of its content. There may be high levels of enzymes, surface active materials or salts in the output. The pH can also vary dramatically towards either acidic or alkaline. Physical stress will arise if the patient is mobile due to abrasion and chaffing of the already damaged skin. Infection and irritation are also likely to result from high levels or micro-organisms in the perineal area, producing toxic and irritant materials during metabolism. Their effects will be accelerated by humid and warm conditions.

Non adhesive hydrogel compositions are of ever increasing application for protecting skin and for applying pharmaceutical agents via the skin. Hydrogels are polymers which can absorb a significant quantity of water without losing their structural integrity. However these are of limited mechanical strength and must be frequently reapplied. Other synthetic skin compositions are available, which are applied as gels and dry in situ into flexible waterproof barriers. These compositions provide a reasonable protective function but may not provide the correct healing and repair environment.

Unfortunately at present there is no single product or system which provides the combined healing, repair and/or protective functions which are required with the medical conditions which affect a significant percentage of the population.

Accordingly there is a need for a healing and protective barrier composition for application in sealing manner to human or animal skin, which may be rendered adhesive, enabling its use to secure medical devices to the skin without leakage,. and which is easy to remove without physical stress to the skin and without leaving a residue on the skin, and is able to withstand changes in temperature and contact with excoriating fluids, without degeneration of the seal, and/or being relatively free from potential allergens, and not liable to cause irritation, and which is permeable or moisture absorbing, allowing moisture to evaporate from the skin's surface for healing and repair and lowered susceptibility to irritant substances, which has temperature regulating properties preventing conditions which encourage micro-organism repair, and is impermeable to bacteria thereby providing a protective barrier to infection. Moreover the composition should be suited to application in all manner of conditions and to all regions of the body, with the different demands on toughness, flexibility and the like.

We have now surprisingly found a composition which acts as a protective barrier that allows continued use of adhesive medical devices without the need to interrupt treatment or to use non preferred appliances, and/or provides a tough, flexible and robust synthetic skin, and which moreover provides a healing and/or repair environment adjacent the skin which optionally allows an adhesive appliance to be removed without trauma, physical stress or damage to the skin.

It is a particular advantage that the composition of the present invention significantly reduces the costs incurred in repairing the damage caused by adhesive or non-adhesive medical appliances and/or caused by contact with excoriating fluids, in alleviating the stress to the patient and in prolongation of a condition due to interrupted treatment or use of inconvenient appliances due to adverse damage or reaction of the skin.

The composition of the invention meets the above mentioned objects in admirable manner, in particular combining the diverse and numerous criteria which are required for a true synthetic skin which is moreover resistant to physical stress. In particular it has been found that the composition enables the skin to breathe and exchange moisture but provides a barrier to bacteria and infection.

Accordingly in its broadest aspect there is provided a composition for application to human or animal skin comprising first and second fluid components, wherein the first component is adapted to be applied to contact the skin, and the second component is adapted to be applied to contact the first component, whereby first and second components in combination are adapted to provide a bilayer comprising a therapeutic layer to contact the skin and a (semi) solid barrier layer, wherein the bilayer is adapted to provide a cohesion which is less than its adhesion.

Preferably the second component contacts the first component to form a barrier layer disposed on top of a beneficial healing/therapeutic layer. Optionally a superficial layer provides an interface with an adhesive or support component which may be applied as a third component to aid adhesion of medical appliances, or to support or absorb fluids.

Reference herein to adhesion is the ability to join two different surfaces, for example the skin and a medical device such as an ostomy appliance. When the adhesive is occlusive, good adhesion to wet skin is important in order to provide security.

Reference herein to cohesion is to the internal strength of a component itself, that is its ability to stick to itself. An adhesive with higher cohesion than adhesion to the skin can be removed in one piece, whereas adhesive residues will remain if cohesion is lower than adhesion.

Accordingly it will be apparent that the composition of the invention provides at least a bilayer composite structure, the therapeutic Iavcr being of sufficient cohesion to retain the barrier layer in place, but being capable of cleaving when the barrier layer is removed, thereby avoiding damage or physical stress to the skin. Moreover the barrier layer is suitably of greater cohesion than the therapeutic layer to ensure the integrity of the barrier film, and optionally to provide sufficient support for an adhesive or non adhesive medical device. Preferably the barrier layer has adhesion equal to or in excess of that of the therapeutic layer, for respective functions as a protective barrier and as an adhesive for supporting medical devices.

In a particular advantage of the invention, it has been found that applying the composition components as respective layers enables the relative cohesion and adhesion benefits to be obtained, and also the formation of the barrier as a substantially continuous film or layer over the therapeutic layer. It has been found that these advantages cannot be obtained by simple mixing in situ, or premixing. The layers may be introduced by any known means, for example, by simultaneous or sequential application from similar or different dispensers, or from a single dispenser having means for separating and aligning components prior to application.

The composition of the invention may comprise first and second components as hereinbefore defined, which are respective therapeutic and barrier substrates or their precursors applied to form therapeutic and barrier layers respectively. Alternatively, and preferably the first component comprises at least a therapeutic substrate and a barrier substrate and the second component comprises at least a barrier-forming agent, whereby on contact thereof, diffusion or migration of barrier substrate and/or barrier-forming agent or interface reaction of barrier substrate and barrier- forming agent provides for barrier formation at the interface of the bilayers or in the boundary of the therapeutic layer.

The barrier layer is preferably any ionic, polymeric or other macromolecular species adapted to provide the advantages of the invention.

More preferably the first component comprises a therapeutic substrate and a fluid salt comprising a soluble anion or cation of a barrier substrate adapted to form a barrier layer, and the second component comprises a barrier forming agent such as a fluid salt of the insoluble cation or anion respectively thereof, whereby on contact, an insoluble ionic barrier layer is formed.

Alternatively, first and second components comprise respective reactive repeating units, or repeating units and catalyst or radical initiator, for polymer formation to provide a barrier layer.

Alternatively, first and second components comprise respective low viscosity polymer and viscosity moderator, such as cross-linking agent or the like, to form a high viscosity barrier layer.

Alternatively, first and second components compromise macromolecule and agglomerating agent to form a macromolecular barrier layer.

Preferably the therapeutic and/or barrier layer is readily soluble in a mild, non irritant solvent, for example water optionally including a neutral or slightly acidic solvent such as mild detergent or the like. This is of particular advantage since it enables the simple and frequent reapplication of the composition when desired, for example after replacing a medical device or after cleaning a skin wound, by stress free removal of the barrier film with some residue of therapeutic layer remaining, which may be readily removed by washing.

It is a particular advantage that a detergent may provide a cation which competes with the anion of an ionic barrier layer and/or therapeutic layer thereby destabilising the layer which may be readily removed. Alternatively, a barrier layer may be removed with use of a depolymerisation or deagglomerating agent.

Preferably the composite structure formed by first and second components in combination has a permeability to water vapour in excess of 100 g/m² per 24 hours and less than 2000 gl/² per 24 hours, more preferably in the range 500-1000 g/m² per 24 hours. Preferably the therapeutic and barrier layers in combination require a force of less then 5 Newtons to remove the composite structure in a strip of width 15 mm from the skin using a 180 peel test, more preferably the force should be less than 2.5 Newtons. Preferably the combined layers have sufficient cohesion to withstand a sheer force of up to 2.5 Newtons.

Preferably the composite structure formed by therapeutic and barrier layers in combination is resistant to penetration of particles in the size range up to 20 microns and more preferably in the size range 2-10 microns, for example common bacteria and the like.

Preferably the therapeutic layer is resistant to attack by corrosive fluids, such as digestive fluids, faecal and urinary fluids, alkaline fluids and the like for a period of at least 24 hours.

The first and second components and any superficial and adhesive layer components are suitably fluids, and adapted to be applied by any desired dispensing means and formed into layers.

Reference herein to a fluid includes any flowable or dispensable material selected from flowable powders, dispersions of powders or solids in gas or liquid, semi-solids, liquids or gases or mixtures thereof, which is preferably in the form of an aerosol, dustable powder or supported or unsupported thixotrope, cream, wipe or gel, whereby it is retained at the locus of application in the desired quantity.

The barrier layer may comprise any suitable polymerisable material or variable viscosity material of controlled and stable variability. Variable viscosity may be achieved for a given phase or for transition between phases e.g. fluid to gel or (semi) solid. By this means the composition components may be dispensed in fluid form and may provide in situ the required barrier film.

Preferably a barrier substrate comprises a material adapted for polymerisation, cross-linking, ion exchange or agglomeration, selected from: polysaccharide derived pre-polymers especially alginates and modified alginates, and especially sodium, silver, zinc, manganese and calcium salts thereof;

polysaccharide derived natural gel formers e.g. pectins, for example of citrus origin, polysaccharide gums such as carrageenan, gum acacia, tragacanth, psyllium, seed oil and locust bean gum and preferably guar or karaya gums; chitin and its derivatives for example carboxy methyl chitinosan;

modified celluloses such as hydroxyethyl celluloses and modified versions thereof, hydroxy propyl cellulose and modified versions thereof and carboxymethyl cellulose, and the sodium or potassium salts thereof;

gel forming proteins such as gelatins or derivatives of bovine or porcine origin and muco-peptides;

a synthetic film forming polymer system selected from co-polymers based on methacrylic acid such as methacrylic acid esters, preferably the butyl ester of poly vinyl meiacrylate (PVM)/methacrylic acid (MA) or clathrates of glyceryl poly methacrylate and modified acrylic acid polymers such as Carbopols (available from B F Goodrich);

poly vinyl alcohol pre-polymer;

poly vinyl pyrrolidone and copolymers thereof, vinyl acetate and complexes with for example iodine; and combinations thereof.

Alginates and their fibres are disclosed more fully in “Alginate Fibres and Wound Dressing”, Medical Device Technology, November 96, 32-41, the contents of which are incorporated herein by reference. Barrier substrates may be selected for degree of film porosity, permeability, hardness and the like, for example substrates capable of binding compactly and tightly with barrier forming agents, or capable of polymerising or forming agglomerates in compact and tightly bound form, may be suited for supporting adhesive appliances, whilst the more loosely, dilute bound equivalents may be suited for skin healing or repair, with exoriating fluids. Preferred barrier substrates are salts of “GG, GM and MM” block alginates, of decreasing bond strengths, e.g. Luxara 5307.

Preferably the barrier substrate as hereinbefore defined is contacted with a barrier forming agent by contact of first and second components, whereby the barrier layer is formed. A barrier forming agent may be selected from any suitable agent depending on the nature of the barrier substrate, and is suitably selected from precipitating cations or anions, polymer cross linking agents and viscosity modifiers such as plasticisers and de-watering agents and the like.

Preferably the barrier forming agent is selected from:

polymer cross linking agents such as salts of boric acid for example sodium and potassium borate;

divalent cations such as calcium, barium and magnesium cations of salts, especially lactate salts;

steryl pyridinium salts and modified versions thereof including a formyl or acetyl group;

polymeric materials derived from 1, 2-substituted ethene compounds such as (formyl) substituted styryl pyridinium compounds as disclosed in co-pending GB patent application no. 9619419.6;

tannic acid; and mixtures thereof

Additionally the barrier forming agent may comprise materials selected from a plasticiser or de-watering agent selected from stearates, superabsorbent polymers such as modified starches and poly acrylates, and glycerine.

The barrier substrate or barrier forming agent may have more than one function, for example it may be desired to employ a mixed system of barrier substrates as defined above, or a mixed system of barrier forming agent, optionally with a non-reactive polymer which may also function as a barrier substrate as defined above. For example one polymer may provide transformation of physical form whilst another polymer may provide beneficial effects on rheology or adhesion of the barrier created to the skin surface and/or to an externally worn appliance such as a colostomy bag, urine collection bag etc.

The barrier forming agent may conveniently be provided in the form of an additional cosmetic or therapeutic agent It has been found that a barrier forming agent comprising a divalent calcium ion may be provided as the salt of pure lanolin. Whilst impure lanolin may provide allergic reaction, pure lanolin has re-hydrating and moisturising properties. Substituted lanolins, such as the ethoxylate, resemble surface-active agents and aid skin penetration, particularly if enclosed between the skin and the barrier layer. Agitated lanolin is available in the form of lanosomes which are laminar structures and which can behave as colloidal solutions.

In a preferred embodiment the first component may contact with the second component to yield a gel at the interface, between the layers. For example, divalent/polyvalent ions, such as calcium, magnesium, barium, manganese, silver or zinc salts of e.g. lactic acid as the barrier forming-agent will ion exchange with sodium or potassium ions in alginate base as the barrier substrate to yield a precipitate of calcium, magnesium, barium, manganese, silver or zinc alginate as gel at the interface.

The first component providing the therapeutic layer may also comprise any suitable therapeutic lotion or film or gel or precursor which is permeable to moisture and atmospheric gases, preferably is capable of retaining or exchanging moisture. The first component may be formed from a wide range of suitable materials known in the art for medical application.

Preferably the first component is selected from:

salicylic acid,

triglycerides;

waxes e.g. lanolin, paraffin, castor or bees wax;

silicone and/or mineral oils;

vitamins and their derivatives or precursors such as vitamins A, D, E and

preferably citric acid and pantheon;

salts of sorbic acid;

polyethylene glycol;

glycerine;

surface active agents;

urea;

demethicone;

anti-inflammatory agents;

wound repair agents such as angiogenesis factors and the like; and mixtures thereof.

The composition of the invention may include any additional materials desired to provide further chemical or physical properties as known in the art. Additional materials may be provided as part of the first or second components, or as additional components, optionally providing additional layers adjacent to or co-extensive with first and second component layers.

Additional materials may be incorporated in either of the first or second components and are, for example, selected from any carriers, diluents, adjuvants, preservatives, dispersants, solvents, binders, emulsifying agents, health or repair promoting agents and the like. Preferably additional materials are selected from sequestering agents such as EDTA, buffering agents, dry aerosol carriers such as aluminium chlorohydrate, preservatives, emollients, antibacterial agents and pharmaceutical agents for transdermal drug delivery.

Additional materials present as a third adhesive/support component of the composition may include materials provided in form to give mechanical strength to the composition in its composite structure, or an active material which may be provided on a physical support in manner to provide a third component layer. It is envisaged that a composite structure obtained by applying a composition of the invention may comprise a reinforcing scrim to give mechanical strength, for example a gauze or net could be impregnated with the first and second components as hereinbefore defined. Alternatively an active agent such as activated carbon may be present in a fabric layer, as is commercially available, the fabric being impregnated with the first and second components as hereinbefore defined. Preferably activated carbon may be included for its absorption and binding and immobilisation properties, whereby odour is conveniently absorbed and bacteria are conveniently immobilised.

Additional materials present as a third component of the composition may include supports or carriers for transdermal delivery of therapeutic agents, for example hydrocolloids or liposomes as carriers for gelatin, pectin, carboxymethyl cellulose, polyisobutylene and the like. Preferably such component is provided together with or incorporated in the barrier substrate layer or the second component and fuses into the therapeutic layer.

The herein defined substrates and agents and any such materials may be present in each of the first and second components of the composition in any effective amount. Preferably therapeutic and barrier forming materials or substrate are present in an amount of from 0.5-100 weight percent in their respective components, preferably in an amount of from 35-40 weight percent. The amount of therapeutic or barrier substrate may be selected according to the desired cohesive and adhesive properties and with reference to the amount of barrier forming agent which is required to be incorporated for the same purpose.

Additional materials may be present in an amount of from 0-99.5 weight percent, preferably 1-80 weight percent, more preferably 5-50 weight percent.

It will be appreciated that the composition of the invention is adapted for application in highly convenient manner. The respective components may be provided in a single or in discrete dispensing reservoirs, for example in the form of a single or plurality or multiple dispensing tube, individual application packs provided as single dose pre-packs, metered dose dispensing aerosols, tubes, and the like. The reservoirs may be provided with a common wall which may be ruptured on dispensing, thereby causing contact of the components as desired. The nature of dispensing reservoir may be selected according to the requirements in terms of the need to select total and respective component amounts and ratios, moisture content control, sterile packing and sealing of each dose, and the like.

A preferred dispensing reservoir comprises an impregnated, single use, tissue/wipe for the first component with second component delivered as a flowable powder or gaseous suspension, spray or aerosol.

In a first preferred embodiment the barrier substrate and barrier forming agent are comprised within respective first and second components and first and second components are provided in separate dispensing reservoirs, whereby on contact of first and second components, diffusion or mixing of the barrier substrate and/or barrier forming agent between layers takes place with resultant fusion of layers and barrier formation.

In a second preferred embodiment the first and second components are provided as an imniscible preparation in a single dispensing reservoir. Preferably a barrier substrate is miscible in both first and second components and is premixed with the first component only. On dispensing, the immiscible preparation is thoroughly mixed whereby the barrier substrate is transferred from the first component to the second component by contact diffusion or physical mixing, and the first and second components are adapted to segregate with the first component in contact with the skin and the second component comprising additionally the barrier substrate in contact with the first component as an outer barrier layer which thereby forms a film.

Preferably the composition is dispensed by means of a pump action applicator comprising a pre-mixing unit, thereby ensuring accurate metering. It is a particular advantage that variable metering enables the cohesive and adhesive properties of the second component to be adapted as required, by adapting the ratio of first component, comprising the film forming agent and second component. The applicator may be of aerosol or mechanical pump action type.

Preferably the nature and ratio of respective barrier substrate and barrier forming agent is determined to provide the required moisture and atmospheric gas diffusion, flexibility and the like in addition to the cohesive and adhesive properties. A tough leathery barrier may be selected for support of adhesive appliances, and a soft gelatinous barrier may be selected for aiding healing and skin repair.

In a further aspect there is provided a process for the preparation of a composition as hereinbefore defined comprising providing a first component and a second component adapted to be applied to the skin and to the first component respectively as hereinbefore defined. Preferably the process comprises providing barrier forming components as hereinbefore defined admixed with the first and/or second components in physically separate form, by means of provision of separate reservoirs as hereinbefore defined or in the form of immiscible component phases.

In a further aspect there is provided according to the present invention a component of a composition as hereinbefore defined.

In a further aspect there is provided according to the invention a method for the application of a composition as hereinbefore defined comprising applying the first component to the skin and simultaneously or subsequently applying the second component to the first component in manner to form a barrier film as hereinbefore defined. The method for application may comprise any pre-mixing, pre-metering or partition rupturing steps or the like for the application of a composition as hereinbefore defined.

In a further aspect there is provided according to the present invention a composite structure comprising a composition as hereinbefore defined in dispensable or dispensed form.

In a further aspect there is provided according to the invention a method for removing a composite structure comprising a composition as hereinbefore defined, the method comprising simultaneously or sequentially removing the barrier layer and the therapeutic layer having cohesion less than adhesion. Preferably the barrier layer is peeled off, optionally by adhesion to a medical device which is removed from the skin, with resultant cleavage of the therapeutic layer, whereafter any remaining therapeutic layer is removed with mild solvent.

In a further aspect there is provided according to the invention the use of a composition as hereinbefore defined for application to human or animal skin. The composition may be applied for protective, healing and/or repair purpose, optionally in association with any adhesive or non-adhesive medical device, or any carrier or support for transdermal delivery of therapeutic agent.

Preferably the composition is used for the treatment of any medical condition which causes or results from skin breakdown, for example as hereinbefore defined.

Preferably the composition is for use in conditions requiring use of adhesive appliances applied to the skin to avoid or to alleviate skin damage or in conditions in which excoriating fluids are in contact with the skin to avoid or to alleviate skin damage; and/or in conditions requiring transdermal therapeutic treatment or healing of the skin, to avoid or alleviate skin damage. For example the composition is suited for use with stoma care, incontinence, (breast) prosthesis, wound dressing, skin diseases, transdermal drug delivery and the like.

The invention is now illustrated in non limiting manner with reference to the following figures wherein:

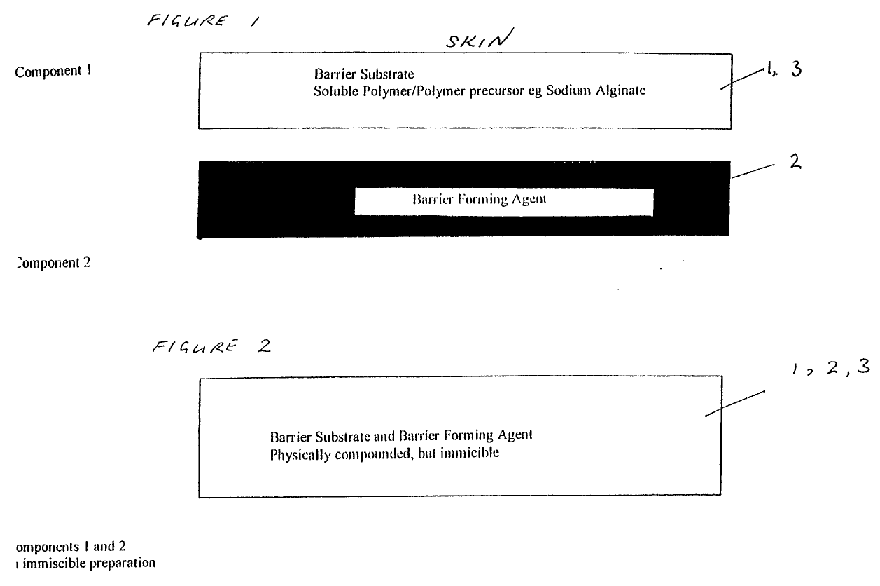

FIGS. 1-4 are diagrammatic schemes of the first and second embodiments of the composition of the invention

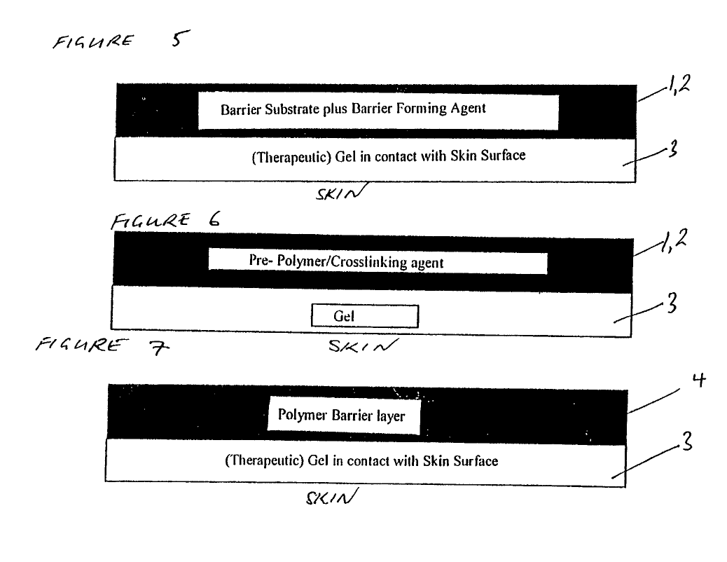

FIG. 5 is a diagrammatic scheme of the dispensed composition according to FIGS. 1-4

FIG. 6 is a diagrammatic scheme showing a composite structure obtained with a composition according to any of FIGS. 1-4.

In FIG. 1 is shown as two separate phases, the first and second components which are suitably provided in separate reservoirs provided independent of each other or having a common wall. The first component provided to contact the skin (not shown) comprises therapeutic agent (3) in the form of lanolin modified to be stable in aqueous phase, and a barrier substrate (1) in the form of sodium alginate as a gel. The second component is provided to contact the first component and comprises a barrier forming agent (2) in the form of a soluble salt barium or calcium) of lactate.

In FIG. 2 is shown first and second components provided as immiscible phases in a single preparation. The immiscible phases comprise the barrier substrate, barrier-forming agent and therapeutic agent (1, 2, 3) as described for FIG. 1. The barrier substrate (1) is pre-mixed in the therapeutic agent (3) but is adapted to diffuse preferentially on contact with the barrier-forming agent (2) and mixing.

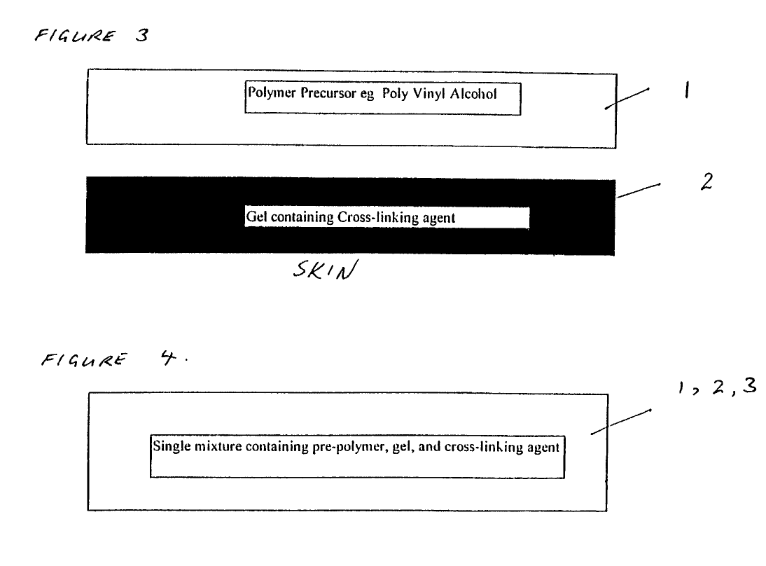

FIG. 3 corresponds to FIG. 1 as described above, but the first component comprises a gel based on hydroxyethyl Cellulose, hydroxy propyl Cellulose, polyethylene glycol, alginates or polysaccharide gums or mixtures thereof and a barrier forming agent (2) such as borate or polymerised formyl steryl pyridinium salts. The second component comprises a barrier substrate (1) in the form of poly vinyl alcohol prepolymer in aqueous solution.

FIG. 4 corresponds to FIG. 2 above but the immiscible phases comprise the prepolymer barrier substrate, gel and crosslinking barrier-forming agent (1, 2) as described for FIG. 2. The barrier-forming agent (2) is pre-mixed in the gel but is adapted to transfer preferentially to the barrier substrate (1) on mixing.

In FIGS. 5 and 6 are shown the dispensed composition obtained on contacting or mixing the components of FIGS. 1-4. The therapeutic layer contacts the skin (not shown) and the barrier layer contacts the therapeutic layer. In the case of FIGS. 2 and 4, the phases preferentially separate with the therapeutic gel phase (3) in contact with the skin as described and illustrated in FIG. 3. In the case of FIG. 1, the barrier substrate (1) is shown as comprised in the barrier layer, having transferred from the skin contacting layer on dispensing. In the case of FIG. 2, the cross linking barrier-forming agent (2) is shown as comprised in the barrier layer, having transferred from the skin contacting layer on dispensing.

In FIG. 7 is shown the composite structure obtained by in situ curing of the dispensed composition. The barrier layer is now shown as comprising the polymerised barrier film (4) and the therapeutic layer is shown as comprising the gel (3).

### EXAMPLE 1

Preparation of Composition of the Invention

Components were prepared as follows:

First component comprising 5% sodium alginate gel (Luxara 5307 TM, A Branwell & Co Ltd) and pure lanolin stabilised in aqueous solution, in the form of an impregnated wipe;

Second component comprising aqueous calcium lactate in the form of an aerosol.

Lanolin is stabilised by condensation with polyoxy ethylene (Aqualose L30 TM) or is treated by ultrasound to form a lanosome.

### EXAMPLE 2

Application of the Composition of Example 1

The composition was applied to the palm of the left hand of 3 subjects using the impregnated wipe followed by a spray with the aerosol. The aerosol is specially designed to function in all orientations to ensure a versatile application technique, and propellant is introduced in the cannister body between the aqueous phase in a flexible pouch and the cannister wall. The spray is forced out of the cannister to contact the first component. The alginate comprises polymeric chains made up predominantly of repeating mixed GM chains adapted to receive an amount of calcium ions and form a high density film, with some swelling in the presence of water.

### EXAMPLE 3

### Removal of the Composition of Example 2

The hands were then washed in water at 40° C., using the subjects normal technique. In each case, one of: Soap (Imperial Leather, Cussons), washing up liquid (Fairy, Procter & Gamble) and skin cleanser (Anti-bacterial hand wash, Tesco) were used. In each case the barrier and therapeutic layers were completely solubilised and removed. This is thought to be because the anionic surface active agents in the soap compete with the alginate for the available calcium ions and due to the concentration and lower solubility product are able to sequester the calcium ions leaving the soluble alginate and lanolin to be removed by normal detergent action.

### EXAMPLE 4

### Stability of Composition

The composition of Example 1 was applied as an impregnated wipe over the bottom of two petri dishes followed by a spray with the aerosol. The film produced was completely covered with either human urine or faces, the dish covered and placed in an incubator at 37° C. for 24 hours. A control film was prepared in the same way, covered in distilled water and incubated. The petri dishes were removed and supernatant contents rinsed away. The film was observed by microscope and attempts made to retrieve each film with tweezers. Each film was removed as a complete disc, with no evidence of any gross or visual changes to the film, other than some staining with the non-control samples. This demonstrated that the film is not compromised in the presence of waste matter.

### EXAMPLE 5

### Patch Testing

Composition was applied according to Example 2 to inner forearms of 3 subjects having dry or normal skin type, as 75 mm×40 mm strips, and then patted dry. The strips were removed in this case after 12 hours from the left arm and after 24 hours from the right arm. The skin condition was observed. There was no sign of skin redness, maceration, or irritation at either 12 or 24 hours.

1. A composition for application to human or animal skin comprising first and second fluid components, wherein the first component is adapted to be applied to contact the skin, and the second component is adapted to be applied to contact the first component, whereby first and second components in combination are adapted to provide a bilayer comprising a therapeutic layer to contact the skin and a (semi) solid barrier layer, wherein the bilayer is adapted to provide a cohesion which is less than its adhesion.

2. A composition as claimed in claim 1 wherein the second component contacts the first component to form a barrier layer disposed on top of a beneficial healing/therapeutic layer.

3. A composition as claimed in claim 1 or 2 which additionally comprises a superficial layer adapted to provide an interface with an adhesive or support component which may be applied as a third component to aid adhesion of medical appliances, or to support or absorb fluids.

4. A composition as claimed in any one of claims 1-3 wherein the layers are introduced by simultaneous or sequential application from similar or different dispensers, or from a single dispenser having means for separating and aligning components prior to application.

5. A composition as claimed in any one of claims 1-4 wherein first and second components are respective therapeutic and barrier substrates or their precursors applied to form therapeutic and barrier layers respectively.

6. A composition as claimed in any one of claims 14 wherein the first component comprises at least a therapeutic substrate and a barrier substrate and the second component comprises at least a barrier forming agent, whereby on contact thereof, diffusion or migration of barrier substrate and/or a barrier forming agent or interface reaction of barrier substrate and barrier forming agent provides for barrier formation at the interface of the bilayers or in the boundary of the therapeutic layer.

7. A composition as claimed in any one of claims 1-6 wherein the barrier layer is an ionic, polymeric or other macro molecular species.

8. A composition as claimed in any one of claims 1-7 wherein the first component comprises a therapeutic substrate and a fluid salt comprising a soluble anion or cation of a barrier substrate adapted to form a barrier layer, and the second component comprises a barrier forming agent in the form of a fluid salt of the insoluble cation or anion respectively thereof, to form on contact an insoluble ionic barrier layer.

9. A composition as claimed in any one of claims 1-8 wherein the therapeutic and/or barrier layer is readily removed with use of a mild, non-irritant solvent, preferably selected from a mild detergent, depolymerisation or deagglomerating agent.

10. A composition as claimed in any one of claims 1-9 which is resistant to penetration of particles in the size range up to 20 microns, such as common bacteria and the like, and which is resistant to attack by corrosive fluids, such as digestive fluids, faecal and urinary fluids, alkaline fluids and the like.

11. A composition as claimed in any one of claims 1-10 wherein first and second components and any superficial and adhesive layer components are selected from fluids comprising any flowable or dispensable material selected from flowable powders, dispersions of powders or solids in gas or liquid, semi-solids, liquids or gases or mixtures thereof, in the form of an aerosol, dustable powder or supported or unsupported thixotrope, cream, wipe or gel.

12. A composition as claimed in any one of claims 1-11 wherein a barrier substrate comprises a material selected from polysaccharide derived pre-polymers especially alginates and modified alginates, and especially sodium, silver, zinc, manganese and calcium salts thereof;
polysaccharide derived natural gel formers e.g. pectins, for example of citrus origin, polysaccharide gums such as carrageenan, gum acacia, tragacanth, psyllium, seed oil and locust bean gum and preferably guar or karaya gums;
chitin and its derivatives for example carboxy methyl chitinosan; modified celluloses such as hydroxyethyl celluloses and modified versions thereof, hydroxy propyl cellulose and modified versions thereof and carboxymethyl cellulose, and the sodium or potassium salts thereof; gel forming proteins such as gelatins or derivatives of bovine or porcine origin and muco-peptides;
a synthetic film forming polymer system selected from co-polymers based on methacrylic acid such as methacrylic acid esters, preferably the butyl ester of poly vinyl methacrylate (PVM)/methacrylic acid (MA) or clathrates of glyceryl poly methacrylate and modified acrylic acid polymers such as Carbopols (available from B F Goodrich);
poly vinyl alcohol pre-polymer,
poly vinyl pyrrolidone and copolymers thereof, vinyl acetate and complexes with for example iodine; and combinations thereof.

13. A composition as claimed in any one of claims 1-12 wherein the barrier forming agent is selected from:
polymer cross linking agents such as salts of boric acid for example sodium and potassium borate;
divalent cations such as calcium, barium and magnesium cations of salts, especially lactate salts;
steryl pyridinium salts and modified versions thereof including a formyl or acetyl group; polymeric materials derived from 1, 2—substituted ethene compounds such as (formyl) substituted stryl pyridinium compounds as disclosed in co-pending GB patent application no. 9619419.6;
tannic acid; and mixtures thereof.

14. A composition as claimed in any one of claims 1-13 wherein the first component providing the therapeutic layer is selected from:
salicylic acid;
triglycerides;
waxes e.g. lanolin, paraffin, castor or bees wax;
silicone and/or mineral oils;
vitamins and their derivatives or precursors such as vitamins A, D, E and preferably citric acid and pantheon;
salts of sorbic acid;
polyethylene glycol;
glycerine;
surface active agents;
urea;
demethicone;
anti-inflammatory agents;
wound repair agents such as angiogenesis factors and the like; and mixtures thereof.

15. A composition as claimed in any one of claims 1-14 which is provided in a single or in discrete dispensing reservoirs, selected from a single plurality or multiple dispensing tube, individual application packs, tissues or wipes provided as single dose pre-packs, metered dose dispensing suspensions, spray, aerosol, tube and the like.

16. A process for the preparation of a composition as defined in any of claims 1-15 comprising providing a first component and a second component adapted to be applied to the skin and to the first component respectively.

17. A composite structure comprising a composition as defined in any of the claims 1-15 in dispensable or dispensed form, or a component thereof.

18. A composition as defined in any of claims 1-15 for use in conditions requiring use of adhesive appliances applied to the skin to avoid or to alleviate skin damage or in conditions in which excoriating fluids are in contact with the skin to avoid or to alleviate skin damage.

19. A composition as defined in any of claims 1-15 for use in conditions requiring transdermal therapeutic treatment or healing of skin, to avoid or alleviate skin damage.

20. A composition for use with stoma care, incontinence, (breast) prosthesis, wound dressing, skin diseases or transdermal drug delivery.
